(19) United States
(12) Patent Application Publication
(10) Pub. No.: US 2017/0180020 A1
(43) Pub. Date: Jun. 22, 2017

(54) PER-TONE PRECODING FOR DOWNLINK MIMO TRANSMISSION

(71) Applicant: QUALCOMM Incorporated, San Diego, CA (US)

(72) Inventors: June NAMGOONG, San Diego, CA (US); Alexandros MANOLAKOS, San Diego, CA (US); Joseph Binamira SORIAGA, San Diego, CA (US); Tingfang JI, San Diego, CA (US)

(21) Appl. No.: 15/377,934

(22) Filed: Dec. 13, 2016

Related U.S. Application Data
(60) Provisional application No. 62/269,920, filed on Dec. 18, 2015.

(51) Int. Cl. H04B 7/04

(52) U.S. Cl. CPC H04B 7/0456; H04W 84/042

(57) ABSTRACT

In an aspect of the disclosure, a method, a computer-readable medium, and an apparatus are provided. The apparatus may be a base station. The base station estimates a first channel matrix observed by a first UE. The base station also applies a SVD to the first channel matrix to obtain a left singular vector matrix and a right singular vector matrix of the first channel matrix. The base station further determines a first precoding matrix based on a product of the right singular vector matrix and a conjugate transpose of the left singular vector matrix. The base station yet further applies the first precoding matrix to at least one first symbol to generate one or more precoded symbols. The base station transmits the one or more precoded symbols.

### CROSS-REFERENCE TO RELATED APPLICATION(S)

This application claims the benefit of U.S. Provisional Application Ser. No. 62/269,920, entitled “Per-tone Precoding for Downlink MIMO Transmission” and filed on Dec. 18, 2015, which is expressly incorporated by reference herein in its entirety.

### BACKGROUND

Field

The present disclosure relates generally to communication systems, and more particularly, to techniques of per-tone precoding at an evolved Node B (eNodeB) for downlink multiple input multiple output (MIMO) transmission.

Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer-readable medium, and an apparatus are provided. The apparatus may be a base station. The base station estimates a first channel matrix observed by a first user equipment (UE). The base station also applies a singular value decomposition (SVD) to the first channel matrix to obtain a left singular vector matrix and a right singular vector matrix of the first channel matrix. The base station further determines a first precoding matrix based on the left singular vector matrix and the right singular vector matrix. The base station yet further applies the first precoding matrix to at least one first symbol to generate one or more precoded symbols. The base station transmits the one or more precoded symbols.

In another aspect of the disclosure, a method, a computer-readable medium, and an apparatus are provided. The apparatus may be a base station. The base station selects a subset of rows of the respective first channel matrix of each of the plurality of UEs based on a respective number of layers of symbols directed to the each UE. The base station determines an augmented channel matrix based on the subset of rows of the respective first channel matrix of each of the plurality of UEs. The base station determines a first precoding matrix based on the left singular vector matrix and the right singular vector matrix of the augmented channel matrix. The base station applies the first precoding matrix to at least one first symbol to generate one or more precoded symbols. The base station transmits the one or more precoded symbols.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating communication between an eNodeB and a UE.

FIG. 8 is a diagram illustrating communication between an eNodeB and two or more UEs.

FIG. 9 is a flow chart of a method (process) for determining a precoding matrix.

FIG. 10 is a flow chart of another method (process) for determining a precoding matrix.

FIG. 11 is a conceptual data flow diagram illustrating the data flow between different means/components in an exemplary apparatus.

FIG. 12 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

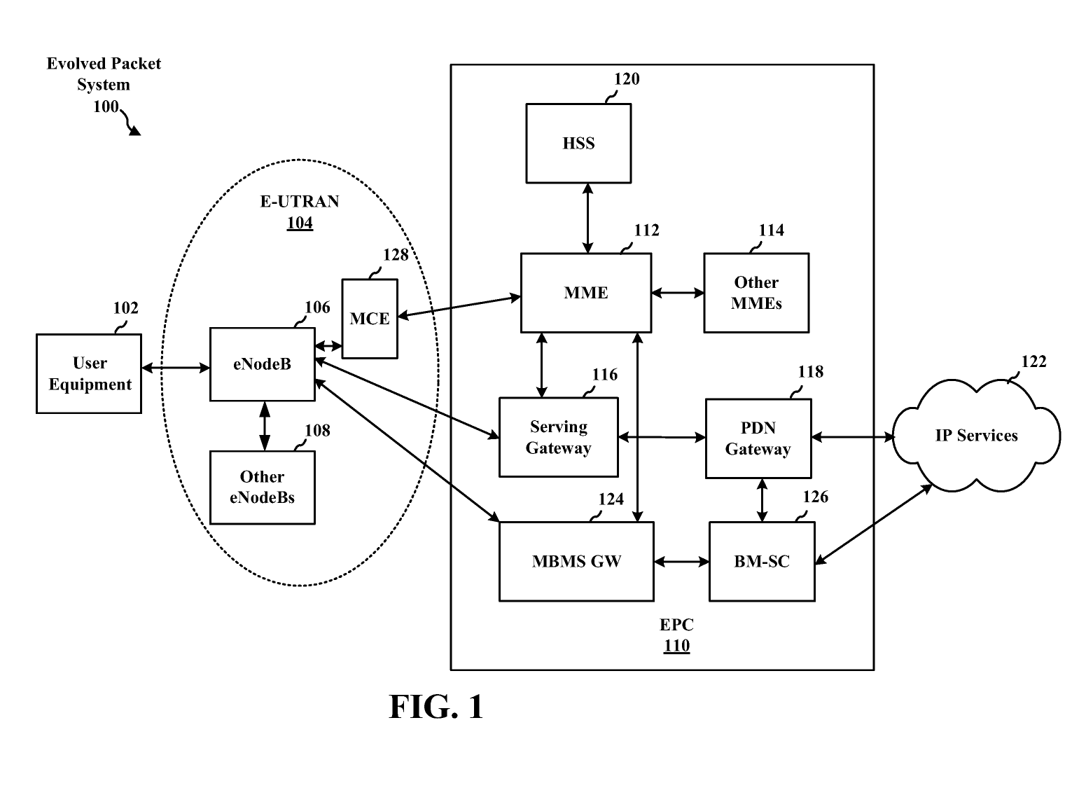

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a public land mobile network (PLMN), and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

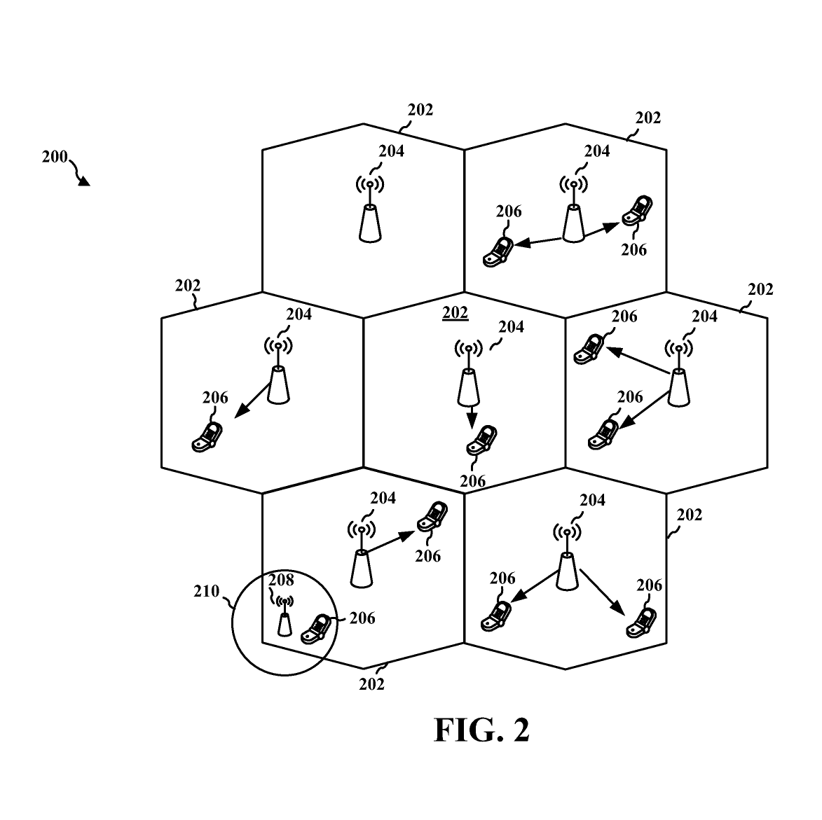

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving a particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

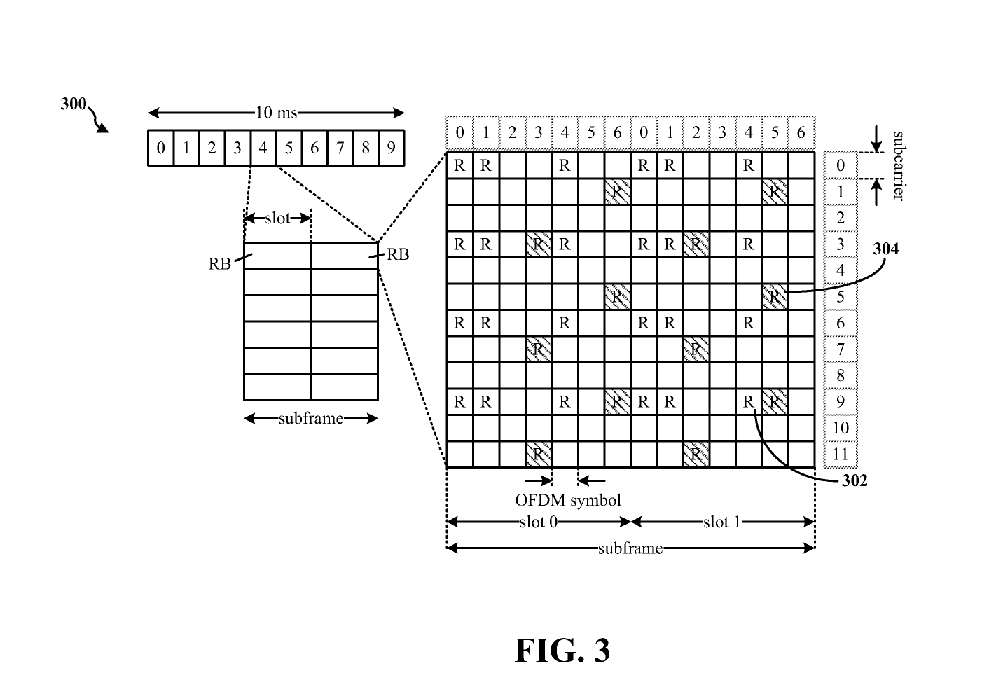

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

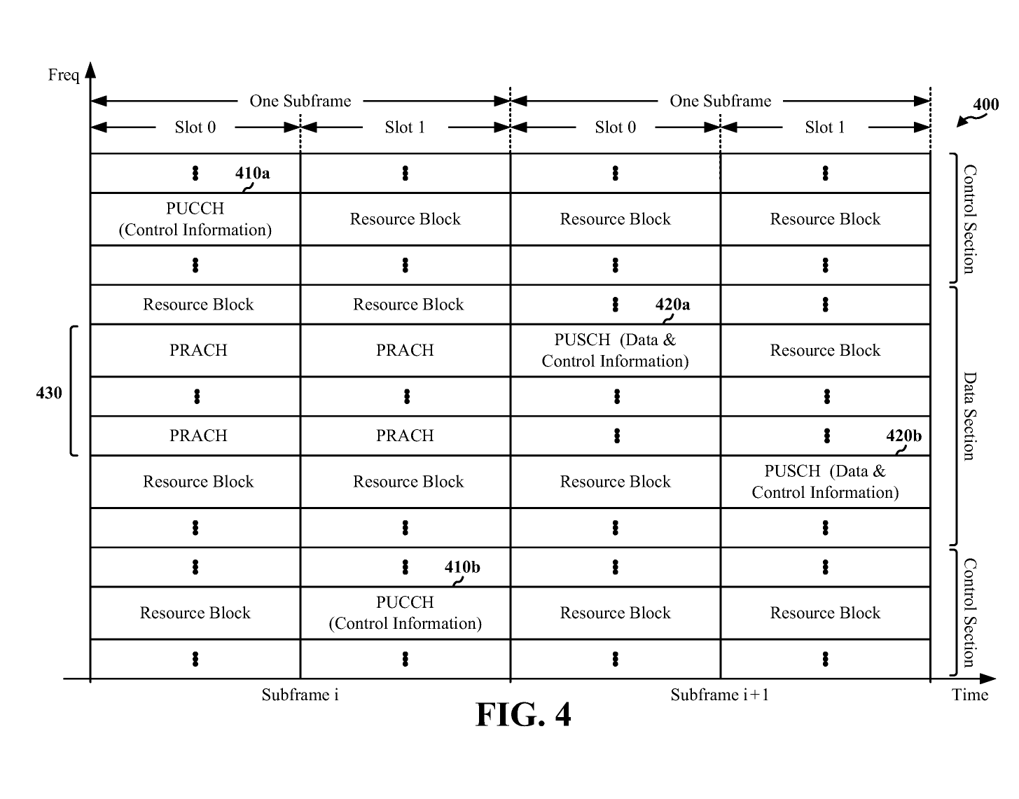

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make a single PRACH attempt per frame (10 ms).

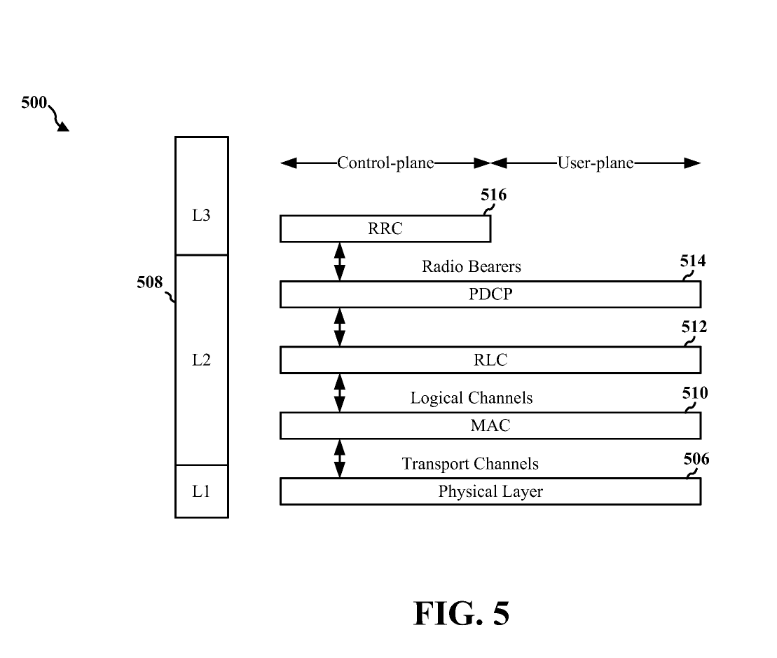

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

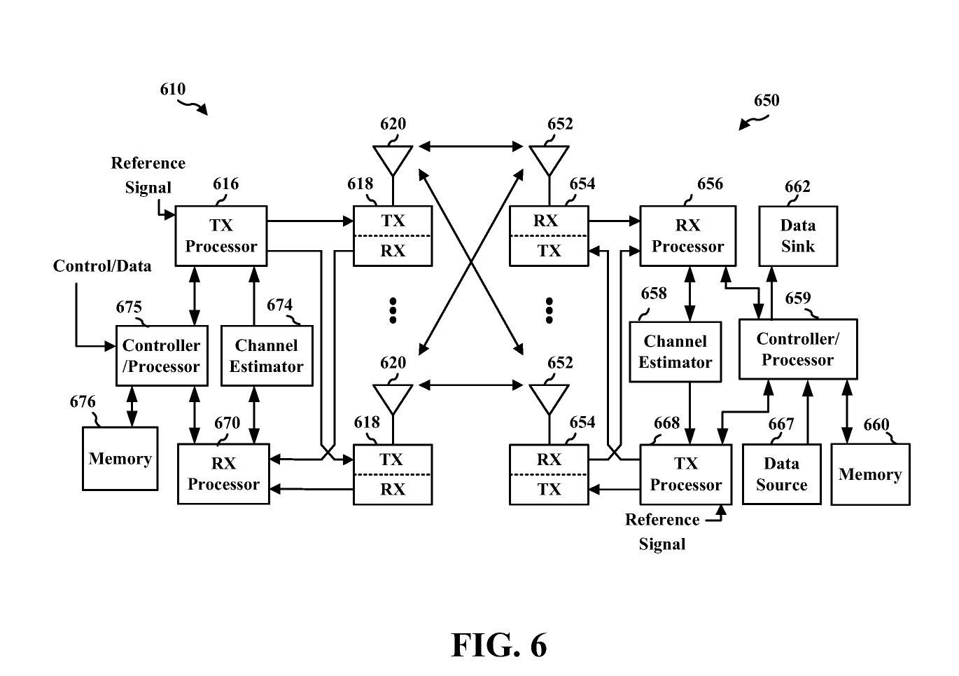

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor 659 can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

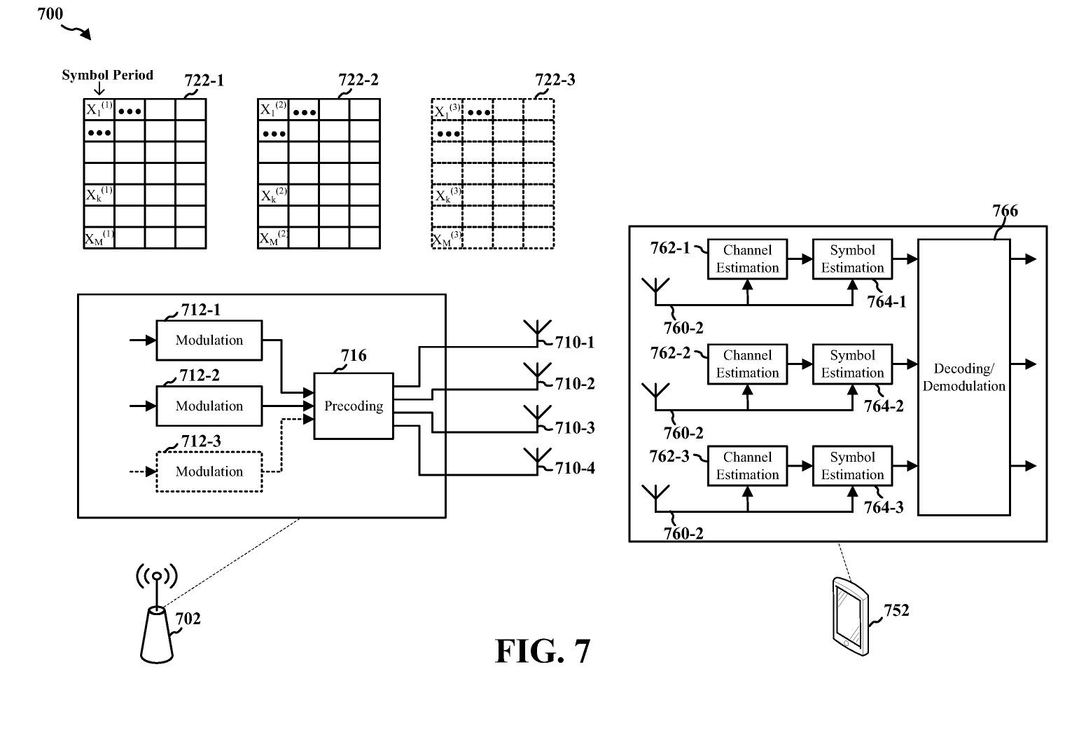

FIG. 7 is a diagram 700 illustrating communication between an eNodeB and a UE. An eNodeB 702 has a number Nₜ antennas. The eNodeB 702 may transmit L layers of symbols to a UE 752. L may be any suitable integer that is greater than 0. The UE 752 has a number Nᵣ antennas and receives the symbols transmitted from the eNodeB 702.

In a first example, the eNodeB 702 has 4 antennas 710-1, 710-2, 710-3, 710-4 (i.e., Nₜ is 4). The UE 752 has 3 antennas 760-1, 760-2, 760-3 (i.e., Nᵣ is 3). Further, the number L of layers transmitted by the eNodeB 702 is equal to the number Nᵣ of antennas of the UE 752. In other words, L is 3 in this example. Further, the eNodeB 702 may employ L modulation components (e.g., modulation components 712-1, 712-2, 712-3) that each receive a sequence of bits and map the bits into a symbol block 722-1, 722-2, 722-3. The symbol blocks 722-1, 722-2, 722-3 each may contain symbols on M tones (e.g., 100) in one or more symbol periods. In certain configurations, the M tones may be contiguous in the frequency domain. In one symbol period, each of the modulation components 712-1, 712-2, 712-3 sends a layer of symbols (e.g., one symbol on each of the M tones from the respective generated symbol block 722-1, 722-2, 722-3) to a precoding component 716. Subsequently, on each of the M tones, the precoding component 716 precodes L symbols (one symbol from each of the L layers) to generate Nₜ precoded symbols, each of which is to be transmitted by a respective one of the antennas 710-1, 710-2, 710-3, 710-4.

The UE 752 receives the precoded symbols from the eNodeB 702 at the antennas 760-1, 760-2, 760-3. Each of the precoded symbols received by the antennas 760-1, 760-2, 760-3 are processed by the channel estimation component 762-1, 762-2, 762-3 and a symbol estimation component 764-1, 764-2, 764-3 for processing. In particular, the received signals include demodulation reference signals (DMRS) or UE-specific reference signals (UE-RSs). The channel estimation component 762-1, 762-2, 762-3 may perform channel estimation based on the DMRSs. Further, the processed signals are sent to a decoding/demodulation component 766 for decoding and demodulation.

In the present disclosure, xₖ^{(v)} denotes a symbol from the v^{th} layer to be transmitted on the k^{th} tone. In one symbol period, the modulation components 712-1, 712-2, 712-3 send, on the k^{th} tone, xₖ⁽¹⁾, xₖ⁽²⁾, . . . , xₖ^{(L)} to the precoding component 716. The precoding component 716 may use xₖ⁽¹⁾, xₖ⁽²⁾, . . . , xₖ^{(L)} to form an L×1 vector xₖ:

xₖ=[xₖ⁽¹⁾,xₖ⁽²⁾, . . . ,xₖ^{(L)}]^{T}.

For example, the precoding component 716 receives, on the 1^{st} tone, x₁⁽¹⁾, x₁⁽²⁾, and x₁⁽³⁾ from the modulation components 712-1, 712-2, 712-3 and forms x₁, which is [x₁⁽¹⁾, x₁⁽²⁾, x₁⁽³⁾]^{T}. The precoding component 716 similarly receives symbols on the 2^{nd} tone, the 3^{rd} tone, and so on.

Upon receiving xₖ, the precoding component 716 applies a precoding matrix Pₖ to xₖ to transform xₖ to an Nₜ×1 vector sₖ:

sₖ=[sₖ⁽¹⁾,sₖ⁽²⁾, . . . ,sₖ^{(N}^{ₜ}⁾]^{T}.

sₖ^{(j)} denotes a precoded symbol to be transmitted by the j^{th} antenna on the k^{th} tone. In the first example, the precoding component 716 transforms [xₖ⁽¹⁾, xₖ⁽²⁾, . . . , xₖ⁽³⁾]^{T} to [s₁⁽¹⁾, s₁⁽²⁾, s₁⁽³⁾, s₁⁽⁴⁾]^{T}. The precoding component 716 may use the techniques described infra to generate the respective precoding matrix for each of the M tones.

The precoding component 716 initially obtains a channel matrix for the UE 752. For example, the UE 752 may transmit sounding reference signals (SRSs) to the eNodeB 702. Using the received SRS (e.g., taking advantage of UL/DL channel reciprocity of a TDD system), the eNodeB 702 may estimate DL channel matrices for the UE 752. More specifically, for the k^{th} tone, the eNodeB 702 estimate a channel matrix Hₖ.

In a first technique to determine a precoding matrix Pₖ, the precoding component 716 may apply singular value decomposition (SVD) to Hₖ such that:

Hₖ=UₖΣₖVₖ^{H}.

Hₖ is an Nᵣ×Nₜ matrix. Σₖ is an Nᵣ×Nᵣ diagonal matrix. Uₖ is an Nᵣ×Nᵣ left singular vector matrix. Vₖ is an Nₜ×Nᵣ right singular vector matrix. The columns of Uₖ and Vₖ each may form an orthonormal set. In this configuration, the precoding component 716 may use Vₖ as the precoding matrix Pₖ for the k^{th} tone. The choices of Vₖ available to the precoding component 716, however, may not be unique. For example, UₖΘₖ and VₖΘ_{K} may also be the left singular vector matrix and right singular vector matrix of Hₖ, where Θₖ is an Nᵣ×Nᵣ diagonal matrix with the diagonal elements having unit amplitude. That is, |Θₖ(i,i)| is 1, where i is from 1 to Nᵣ.

In the first technique, as described supra, the eNodeB 702 may use Vₖ as the precoding matrix Pₖ for the k^{th} tone. The signals transmitted by the eNodeB 702, and observed by the UE 752, on the k^{th} tone is HₖPₖxₖ:

HₖP_{K}xₖ=HₖVₖxₖ=UₖΘₖΣₖxₖ.

As described supra, there may be ambiguity in the phase of both the right singular vector matrix and the left singular vector matrix, which leads to the phase ambiguity across the tones of precoded channels received by the UE 752. On the other hand, having continuity of the precoding matrices applied at the eNodeB 702 to the tones in the symbol blocks 722-1, 722-2, 722-3 across the tones, so that the wide-band channel estimation at the UE 752 is possible may be desirable. The channel estimation accuracy may increase as the bandwidth increases. The ambiguity described supra leads to discontinuity across the tones, which increases the delay spread in the precoded channels. As such, the accuracy of the channel estimation may not be optimal and, thus, the UE throughput may not be optimal.

In a second technique to determine a precoding matrix Pₖ′, the precoding matrices Pₖ′ are changed to address the ambiguity and discontinuity described supra. For any Nᵣ×Nᵣ unitary matrix Ξₖ, the precoding component 716 may use Vₖ Ξ_{K} as a precoding matrix Pₖ′ to achieve the same capacity as the precoding matrix Pₖ (i.e., Vₖ). Furthermore, the precoding component 716 may choose Uₖ^{H} as Ξₖ. As such, the precoding component 716 determines:

Pₖ′=VₖUₖ^{H}

Pₖ′ is an Nᵣ×Nᵣ matrix. (Such a precoding method will be referred to as “Rotated SVD (RSVD)” precoding.) As such, the phase ambiguity in the left singular vector matrix and the right singular vector matrix may be eliminated. More specifically, the signals observed by the UE 752 are:

HₖP′ₖxₖ=HₖVₖUₖ^{H}xₖ=UₖΣₖUₖ^{H}xₖ.

As shown, Pₖ′ removes the arbitrary phase introduced by the left singular vector matrix and the right singular vector matrix on the precoded channels. More specifically, for the k^{th} tone, the observed signals at the UE 752 are:

$${H}_{k} {P}_{k}^{′} {\underline{x}}_{k} = {\sum }_{v} {\sum }_{l = 1}^{Nr} \sqrt{{λ}_{kl}} {u}_{kl} {u}_{kl}^{*} ( v ) {x}_{k}^{( v )}$$

where \sqrt{λₖₗ} is the l-th diagonal element of Σₖ and uₖₗ is the l-th column vector of Uₖ. This means that the observed channel for the v^{th} layer signal is Σₗ₌₁^{N}^{ᵣ}\sqrt{λₖₗ}uₖₗuₖₗ*(v). The singular vectors are coherently combined on the v^{th} element, but not on the other elements. As such, the v^{th} layer is received strongest, e.g., highest energy, on the v^{th} receive antenna.

In a second example, as described supra in the first example, the eNodeB 702 has Nₜ (e.g., 4) antennas and the UE 752 has Nᵣ (e.g., 3) antennas. The number L of layers at the eNodeB 702, however, is less than the number (Nᵣ) of antennas of the UE 752. In this second example, L is 2. Accordingly, the eNodeB 702 may employ 2 modulation components (e.g., modulation components 712-1, 712-2) that each receive a sequence of bits and map the bits into a symbol block 722-1, 722-2.

As described supra, in one symbol period, each of the modulation components sends a layer of symbols (e.g., one symbol on each of the M tones from the respective generated symbol block 722-1, 722-2) to the precoding component 716.

Subsequently, on each of the M tones, the precoding component 716 precodes L symbols (one symbol from each of the L layers) to generate Nₜ precoded symbols, each of which is to be transmitted by a respective one of the antennas 710-1, 710-2, 710-3, 710-4. Further, as described supra, the precoding component 716 may use xₖ⁽¹⁾, xₖ⁽²⁾, . . . , xₖ^{(L)} to form an L×1 (e.g., 2×1) vector xₖ:

xₖ=[xₖ⁽¹⁾,xₖ⁽²⁾, . . . ,xₖ^{(L)}]^{T}.

Further, as described supra, the eNodeB 702 may estimate, e.g., based on SRSs received from the UE 752, a channel matrix Hₖ for the k^{th} tone. The Hₖ may be an Nᵣ×Nₜ matrix. Using the second technique described supra, the precoding component 716 may determine Pₖ′, which is an Nᵣ×Nᵣ matrix. In this second example, L is less then Nᵣ. Thus, Pₖ′ may not be used as a precoding matrix to transform xₖ to sₖ. The eNodeB 702 may use a third technique as described infra to determine a Pₖ″, which is an Nₜ×L matrix.

In a first option of the third technique, the precoding component 716 may select L columns from the precoding matrix Pₖ′ to form a Pₖ″ based on a rule. For example, the precoding component 716 may select the initial L columns of the Pₖ′.

Further, Hₖ may have Nᵣ rows, each corresponding to an antenna at the UE 752. In a second option of the third technique, the precoding component 716 may compute the total energy on all the tones (e.g., from the 1^{st} tone to the M^{th} tone) received at each receive antenna. The total energy received at the j^{th} antenna may be denoted as E^{(j)}. The precoding component 716 may compute E^{(f)} as:

$${E}^{( j )} = {\sum }_{k = 1}^{M} {‖ {H}_{k} ( j , \text{:} ) ‖}^{2}$$

where ∥Hₖ(j, :)∥ is 1-2 norm of the j^{th} row of the Hₖ. ∥Hₖ(j, :)∥² may be considered as the energy of the channel received at the j^{th} antenna of the UE 752 on the k^{th} tone.

The precoding component 716 may select L antennas of the antennas of the UE 752 based on certain rules. In this example, based on the E^{(j)}, the precoding component 716 may determine L antennas of the antennas of the UE 752 that have the L largest received energy. The precoding component 716 may select the corresponding rows of the Hₖ to form a reduced channel matrix Hₖ′. Hₖ′ is an L×Nₜ matrix. More specifically, idx(L) denotes the indices of the L selected antennas. Hₖ′ may be determined as:

Hₖ′=Hₖ(idx(L),:).

Subsequently, the precoding component 716 may, similarly to the second technique, apply SVD to the Hₖ′:

H′ₖ=U′ₖΣ′ₖV′ₖ^{H}.

As in the second technique, the precoding component 716 determines:

H′ₖ=V′ₖU′ₖ^{H}.

Pₖ″ is an Nₜ×L matrix. As such, the precoding component 716 can apply Pₖ″ to xₖ in order to transform xₖ to precoded symbols sₖ. Subsequently, the precoded symbols are transmitted by the antennas 710-1, 710-2, 710-3, 710-4.

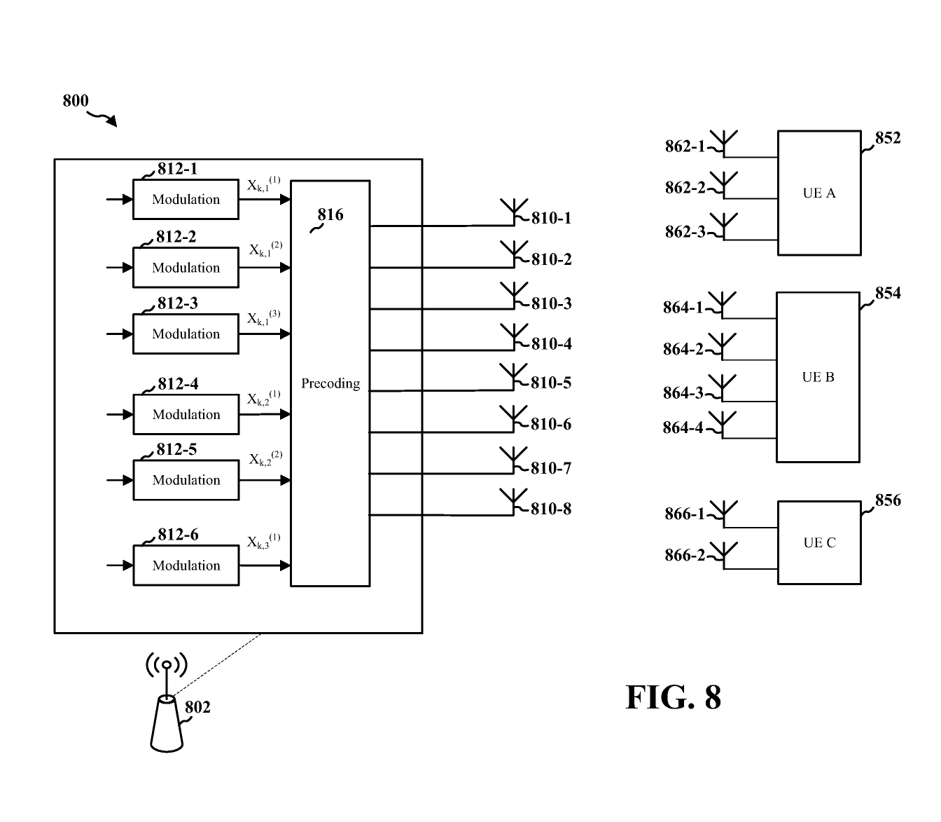

FIG. 8 is a diagram 800 illustrating communication between an eNodeB and two or more UEs. An eNodeB 802 has a number Nₜ antennas. The eNodeB 802 may transmit L layers of symbols to a number Γ of UEs. Γ is an integer greater than 1. L may be any suitable integer that is greater than 0. A respective subset of the L layers, i.e., L_{y} layers, of symbols may be directed to a y^{th} UE. More specifically:

L=L₁+L₂+ . . . +L_{y}+ . . . +L_{T}.

The y^{th} UE has a number N_{r,y} antennas and receives the symbols transmitted on the L_{y} layers from the eNodeB 802.

In a third example, the eNodeB 802 has 8 antennas 810-1 to 810-8 (i.e., Nₜ is 8). Further, the eNodeB 802 transmits 6 layers (i.e., L is 6) of symbols to 3 UEs 852, 854, 856. The UE A 852 has 3 antennas 862-1 to 862-3 (i.e., N_{r,1} is 3). The UE B 854 has 4 antennas 864-1 to 864-4 (i.e., N_{r,2} is 4). The UE C 856 has 2 antennas 866-1, 866-2 (i.e., N_{r,3} is 2). Further, the eNodeB 802 may employ L modulation components (e.g., modulation components 812-1 to 812-6) that each receive a sequence of bits and map the bits into a symbol block. The symbol blocks each may contain symbols on M tones (e.g., 100) in one or more symbol periods. In certain configurations, the M tones may be contiguous in the frequency domain. In one symbol period, each of the modulation components 812-1 to 812-6 sends a layer of symbols (e.g., one symbol on each of the M tones from the respective generated symbol block) to a precoding component 816.

In this example, L₁ (e.g., 3) layers from the modulation components 812-1 to 812-3 are directed to the UE A 852. L2 (e.g., 2) layers from the modulation components 812-4, 812-5 are directed to the UE B 854. L3 (e.g., 1) layer from the modulation components 812-6 is directed to the UE C 856. Furthermore, on each of the M tones, the precoding component 816 precodes L symbols (one symbol from each of the L layers) to generate Nₜ precoded symbols, each of which is to be transmitted by a respective one of the antennas 810-1 to 810-8.

The UE 852, 854, or 856 receives the precoded symbols from the eNodeB 802 at the antennas of that UE. Similar to what was described supra referring FIG. 7, each of the antennas transmits the received signals to a channel estimation component and a symbol estimation component for processing. In particular, the received signals include DMRSs (UE-RSs). The channel estimation component may perform channel estimation based on the DMRSs. Further, the processed signals are sent to a decoding/demodulation component for decoding and demodulation.

In the present disclosure, x_{k,y}^{(v)} denotes a symbol from the v^{th} layer, directed to the y^{th} UE, and to be transmitted on the k^{th} tone. In this third example, in one symbol period, the modulation components 812-1 to 812-6 send, on the k^{th} tone, x_{k,1}⁽¹⁾, x_{k,1}⁽²⁾, x_{k,1}⁽³⁾, x_{k,2}⁽¹⁾, x_{k,2}⁽²⁾, x_{k,1}⁽³⁾ to the precoding component 816. The precoding component 816 may use symbols on the k^{th} tone directed to the y^{th} UE to form an L_{y}×1 vector x_{k,y}:

x_{k,y}=[x_{k,y}⁽¹⁾,x_{k,y}⁽²⁾, . . . ,x_{k,y}^{(L}^{_{y}}⁾]^{T}.

For example, with respect the UEs 852, 854, 856, the vectors on the k^{th} tone are:

x_{k,1}=[x_{k,1}⁽¹⁾,x_{k,1}⁽²⁾,x_{k,3}^{(S)}]^{T},

x_{k,2}=[x_{k,2}⁽¹⁾,x_{k,2}⁽²⁾]^{T},

x_{k,3}=[x_{k,3}⁽¹⁾]^{T}.

Further, the precoding component 816 may concatenate the vectors for all the UEs to obtain a combined L×1 vector xₖ:

xₖ=[x_{k,3}^{T},x_{k,2}^{T}, . . . ,x_{k,1}^{T}]^{T}.

For example, the precoding component 816 receives, on the 1^{st} tone, x_{1,1}⁽¹⁾, x_{1,1}⁽²⁾, x_{1,1}⁽³⁾, x_{1,2}⁽¹⁾, x_{1,2}⁽²⁾, and x_{1,3}⁽¹⁾ from the modulation components 812-1 to 812-6 and forms x₁, which is [x_{1,1}⁽¹⁾, x_{1,1}⁽²⁾, x_{1,1}⁽³⁾, x_{1,2}⁽¹⁾, x_{1,2}⁽²⁾, x_{1,3}⁽¹⁾]^{T}. The precoding component 816 similarly receives symbols on the 2^{nd} tone, the 3^{rd} tone, and so on. Upon receiving xₖ, the precoding component 816 applies a precoding matrix Φₖ to xₖ to transform xₖ to an Nₜ×1 vector sₖ:

sₖ=[sₖ⁽¹⁾,sₖ⁽²⁾, . . . ,sₖ^{(N}^{ₜ₎}]^{T}.

sₖ^{(j)} denotes a precoded symbol to be transmitted by the j^{th} antenna on the k^{th} tone. In this third example, on the 1^{st} tone, the precoding component 816 transforms [x_{1,1}⁽¹⁾, x_{1,1}⁽²⁾, x_{1,1}⁽³⁾, x_{1,2}⁽¹⁾, x_{1,2}⁽²⁾, x_{1,3}⁽¹⁾]^{T} to [s₁⁽¹⁾, s₁⁽²⁾, . . . , s₁⁽⁸⁾]^{T}. The precoding component 816 may use the techniques described infra to generate the respective precoding matrix for each of the M tones.

The precoding component 816 initially obtains a channel matrix on each tone for each UE. As described supra referring to FIG. 7, a y^{th} UE may transmit SRSs to the eNodeB 802 on each tone. Using the received SRS (e.g., taking advantage of channel reciprocity of a TDD system), the eNodeB 802 may estimate DL channel matrices on each tone for the y^{th} UE. More specifically, for the k^{th} tone, the eNodeB 802 estimate a channel matrix H_{k,y} for the y^{th} UE.

The H_{k,y} may be an N_{r,y}×Nₜ matrix. H_{k,y} has N_{r,y} rows, each corresponding to an antenna at the y^{th} UE. The precoding component 816 may compute the total energy on all the tones (e.g., from the 1^{st} tone to the M^{th} tone) received at each receive antenna of the y^{th} UE. The total energy received at the j^{th} antenna of the y^{th} UE may be denoted as E_{y}^{(j)}. The precoding component 816 may compute E_{y}^{(j)} as:

$${E}_{γ}^{( j )} = {\sum }_{k = 1}^{M} {‖ {H}_{k , γ} ( j , \text{:} ) ‖}^{2} ,$$

where ∥H_{k,y}(j, :)∥ is 1-2 norm of the j^{th} row of the H_{k,y}. ∥H_{k,y}(j, :)∥² may be considered as the energy of the channel received at the j^{th} antenna of the y^{th} UE on the k^{th} tone.

The precoding component 816 may select L_{y} antennas of the antennas of the y^{th} UE based on certain rules. In this example, based on the E_{y}^{(j)}, the precoding component 816 may determine L_{y} antennas of the antennas of the y^{th} UE that have the L_{y} largest energy. The precoding component 816 may select the corresponding rows of the H_{k,y} to form a reduced channel matrix H′_{k,y}. H′_{k,y} is an L_{y}×Nₜ matrix. More specially, idx(L)_{y} denotes the indices of the L_{y} selected antennas. H′_{k,y} may be determined as:

H′_{k,y}=H_{k,y}(idx(L)_{y},:).

In this example, 3 layers of symbols are directed to the UE A 852. The UE A 852 has 3 antennas 862-1 to 862-3. As the number of layers is equal to the number of antennas, the precoding component 816 may not need to compute the energy received at each antenna as described supra. The precoding component 816 may select all the antennas 862-1 to 862-3. That is, H_{k,1}′=H_{k,1}. Further, 2 layers of symbols are directed to the UE B 854. The UE B 854 has 4 antennas 864-1 to 864-4. The precoding component 816 may select two antennas, e.g., the 2^{nd} and the 3^{rd} antennas, of the antennas 864-1 to 864-4 as described supra. That is, H_{k,2}′=H_{k,2}([2, 3], :). Furthermore, 1 layer of symbols are directed to the UE C 856. The UE C 856 has 2 antennas 866-1, 866-2. The precoding component 816 may select one antenna, e.g., the 2^{nd} antenna, of the antennas 866-1, 866-2 as described supra. That is, H_{k,3}′=H_{k,3}(2, :).

Subsequently, the precoding component 816 may generate an augmented channel matrix H_{aug,k}, which is an L×Nₜ matrix, on the k^{th} tone based on the reduced channel matrix of each of the Γ UEs. For example, the precoding component 816 may stack the reduced channel matrix of each UE on the k^{th} tone to generate H_{aug,k}:

$${H}_{aug , k} = ( \begin{matrix}{H}_{k , 1}^{′} \\ {H}_{k , 2}^{′} \\ … \\ {H}_{k , γ}^{′} \\ … \\ {H}_{k , Γ}^{′}\end{matrix} )$$

In this example,

$${H}_{aug , k} = ( \begin{matrix}{H}_{k , 1}^{′} \\ {H}_{k , 2}^{′} \\ {H}_{k , 3}^{′}\end{matrix} )$$

Similarly to the second technique, the precoding component 816 may apply SVD to the H_{aug,k}:

H_{aug,k}=U_{aug,k}Σ_{aug,k}V_{aug,k}^{H}.

Σ_{aug,k} is an L×L diagonal matrix. U_{aug,k} is an L×L left singular vector matrix. V_{aug,k} is an Nₜ×L right singular vector matrix.
As in the second technique, the precoding component 816 determines:

Φₖ=V_{aug,k}U_{aug,k}^{H}.

Φₖ is an Nₜ×L matrix (8×6 in this example). As such, the precoding component 816 can apply Φₖ to xₖ in order to transform xₖ to precoded symbols sₖ. Subsequently, the precoded symbols are transmitted by the antennas 810-1 to 810-8 to the Γ UEs.

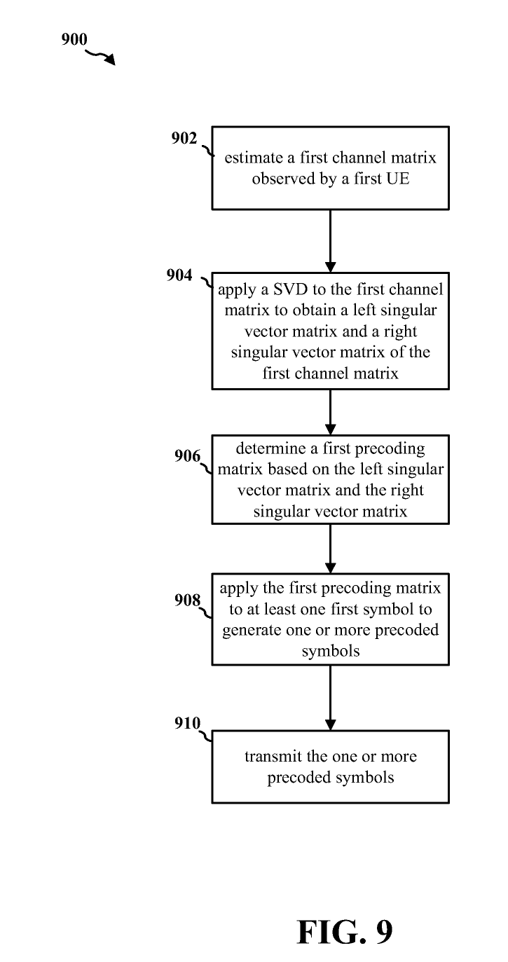

FIG. 9 is a flow chart 900 of a method (process) for determining a precoding matrix. The method may be performed by a base station (e.g., the eNodeB 702).

At operation 902, the base station estimates a first channel matrix observed by a first UE. At operation 904, the base station applies an SVD to the first channel matrix to obtain a left singular vector matrix and a right singular vector matrix of the first channel matrix. At operation 906, the base station determines a first precoding matrix based on the left singular vector matrix and the right singular vector matrix. At operation 908, the base station applies the first precoding matrix to at least one first symbol to generate one or more precoded symbols. At operation 910, the base station transmits the one or more precoded symbols.

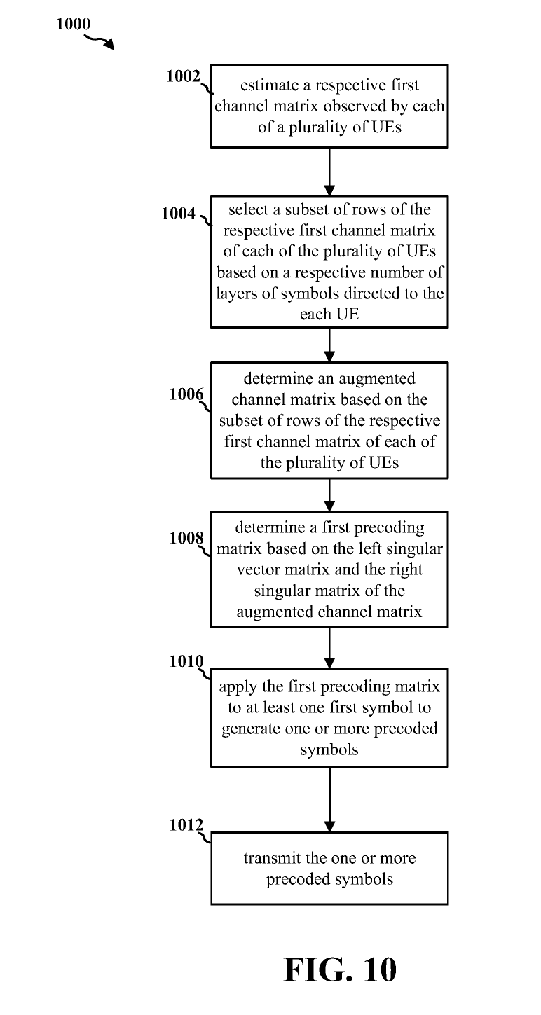

FIG. 10 is a flow chart 1000 of another method (process) for determining a precoding matrix. The method may be performed by a base station (e.g., the eNodeB 802).

At operation 1002, the base station estimates a respective first channel matrix observed by each of a plurality of UEs. At operation 1004, the base station selects a subset of rows of the respective first channel matrix of each of the plurality of UEs based on a respective number of layers of symbols directed to the each UE. At operation 1006, the base station determines an augmented channel matrix based on the subset of rows of the respective first channel matrix of each of the plurality of UEs. At operation 1008, the base station determines a first precoding matrix based on the left singular vector matrix and the right singular vector matrix of the augmented channel matrix. At operation 1010, the base station applies the first precoding matrix to at least one first symbol to generate one or more precoded symbols. At operation 1012, the base station transmits the one or more precoded symbols.

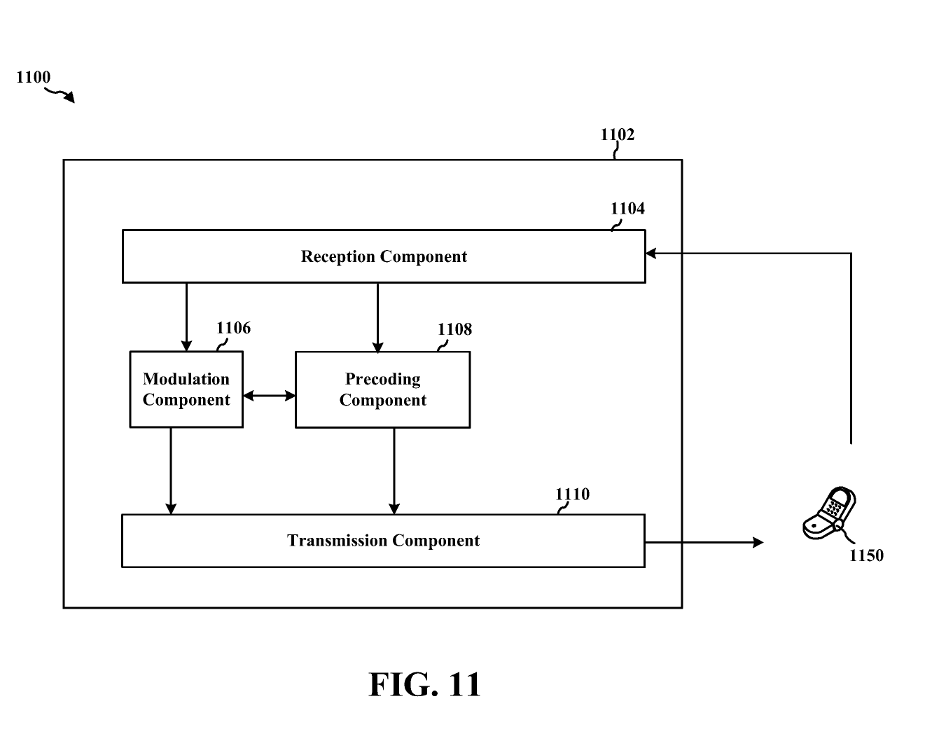

FIG. 11 is a conceptual data flow diagram 1100 illustrating the data flow between different components/means in an exemplary apparatus 1102. The apparatus 1102 may a base station (e.g., the eNodeB 702, eNodeB 802). The apparatus 1102 includes a reception component 1104, a transmission component 1110, a modulation component 1106, and a precoding component 1108. The apparatus 1102 is in communication with a UE 1150.

The reception component 1104, the transmission component 1110, the modulation component 1106, and/or the precoding component 1108 may perform or control each of the operations described supra referring to FIGS. 9-10.

The apparatus may include additional components that perform each of the blocks of the algorithm in the aforementioned flowcharts of FIGS. 9-10. As such, each block in the aforementioned flowcharts of FIGS. 9-10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

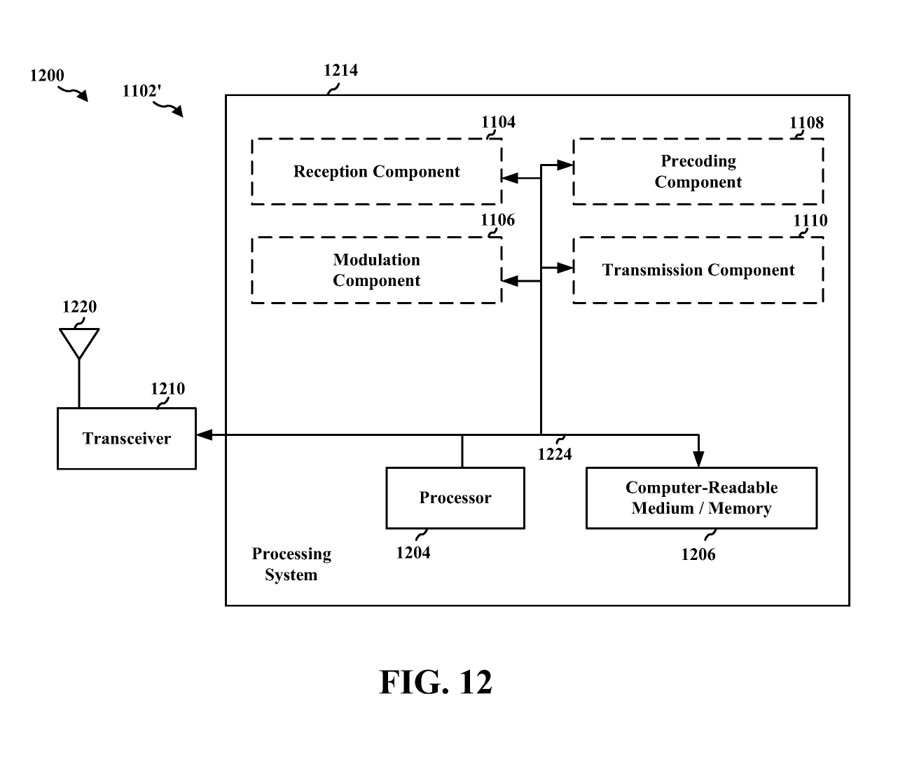

FIG. 12 is a diagram 1200 illustrating an example of a hardware implementation for an apparatus 1102′ employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware components, represented by the processor 1204, the components 1104, 1106, 1108, 1110, and the computer-readable medium/memory 1206. The bus 1224 may also link various other circuits such as timing sources, peripherals, voltage regulators, and power management circuits, which are well known in the art, and therefore, will not be described any further.

The processing system 1214 may be coupled to a transceiver 1210. The transceiver 1210 is coupled to one or more antennas 1220. The transceiver 1210 provides a means for communicating with various other apparatus over a transmission medium. The transceiver 1210 receives a signal from the one or more antennas 1220, extracts information from the received signal, and provides the extracted information to the processing system 1214, specifically the reception component 1104. In addition, the transceiver 1210 receives information from the processing system 1214, specifically the transmission component 1110, and based on the received information, generates a signal to be applied to the one or more antennas 1220. The processing system 1214 includes a processor 1204 coupled to a computer-readable medium/memory 1206. The processor 1204 is responsible for general processing, including the execution of software stored on the computer-readable medium/memory 1206. The software, when executed by the processor 1204, causes the processing system 1214 to perform the various functions described supra for any particular apparatus. The computer-readable medium/memory 1206 may also be used for storing data that is manipulated by the processor 1204 when executing software. The processing system further includes at least one of the components 1104, 1106, 1108, 1110. The components may be software components running in the processor 1204, resident/stored in the computer readable medium/memory 1206, one or more hardware components coupled to the processor 1204, or some combination thereof.

The processing system 1214 may be a component of the eNB 610 and may include the memory 676 and/or at least one of the TX processor 616, the RX processor 670, and the controller/processor 675.

The apparatus 1102/1102′ may be configured to include means for performing each of the operations described supra referring to FIGS. 9-10.

The aforementioned means may be one or more of the aforementioned components of the apparatus 1102 and/or the processing system 1214 of the apparatus 1102′ configured to perform the functions recited by the aforementioned means.

As described supra, the processing system 1214 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication of a base station, comprising:
estimating a first channel matrix observed by a first user equipment (UE);
applying a singular value decomposition (SVD) to the first channel matrix to obtain a left singular vector matrix and a right singular vector matrix of the first channel matrix;
determining a first precoding matrix based on a product of the right singular vector matrix and a conjugate transpose of the left singular vector matrix;
applying the first precoding matrix to at least one first symbol to generate one or more precoded symbols; and
transmitting the one or more precoded symbols.

2. The method of claim 1, wherein the first channel matrix is estimated based on one or more sounding reference signals (SRSs) received from the first UE.

3. The method of claim 1, further comprising:
obtaining a symbol block containing a plurality of symbols on a plurality of tones, wherein the plurality of symbols include the at least one first symbol, wherein the first channel matrix is for a first tone of the plurality of tones, and wherein the at least one first symbol is on the first tone;
determining a precoding matrix for each tone of the plurality of tones other than the first tone;
applying the precoding matrix for each tone of the plurality of tones other than the first tone to one or more symbols of the plurality of symbols on the each respective tone to generate at least one precoded symbol on the each respective tone; and
transmitting the at least one precoded symbol on each respective tone of the plurality of tones other than the first tone.

4. The method of claim 1, wherein a number of layers of the at least one first symbol is equal to a number of antennas of the first UE.

5. The method of claim 1, wherein a number of layers of the at least one first symbol is less than a number of antennas of the first UE,
wherein the determination of the first precoding matrix includes selecting a subset of columns of a product of the right singular vector matrix and a conjugate transpose of the left singular vector matrix to form the first precoding matrix, wherein a number of columns in the subset is equal to the number of layers of the at least one first symbol.

6. The method of claim 1, wherein a number of layers of the at least one first symbol is less than a number of antennas of the first UE, the method further comprising:
determining a subset of the antennas based on reception qualities of the antennas, wherein a number of antennas in the subset is equal to the number of layers of the at least one first symbol; and
removing rows not corresponding to the subset of antennas from the first channel matrix prior to the application of the SVD to the first channel matrix.

7. The method of claim 6, wherein a reception quality of each of the antennas is determined based on an estimated total energy received at the each antenna.

8. The method of claim 6, wherein the antennas in the subset each have a reception quality better than reception qualities of the antennas not included in the subset.

9. An apparatus for wireless communication, the apparatus being a base station, comprising:
means for estimating a first channel matrix observed by a first user equipment (UE);
means for applying a singular value decomposition (SVD) to the first channel matrix to obtain a left singular vector matrix and a right singular vector matrix of the first channel matrix;
means for determining a first precoding matrix based on a product of the right singular vector matrix and a conjugate transpose of the left singular vector matrix;
means for applying the first precoding matrix to at least one first symbol to generate one or more precoded symbols; and
means for transmitting the one or more precoded symbols.

10. An apparatus for wireless communication, the apparatus being a base station, comprising:
a memory; and
at least one processor coupled to the memory and configured to:
estimate a first channel matrix observed by a first user equipment (UE);
apply a singular value decomposition (SVD) to the first channel matrix to obtain a left singular vector matrix and a right singular vector matrix of the first channel matrix;
determine a first precoding matrix based on a product of the right singular vector matrix and a conjugate transpose of the left singular vector matrix;
apply the first precoding matrix to at least one first symbol to generate one or more precoded symbols; and
transmit the one or more precoded symbols.

11. The apparatus for wireless communication of claim 10, wherein the first channel matrix is estimated based on one or more sounding reference signals (SRSs) received from the first UE.

12. The apparatus for wireless communication of claim 10, further comprising:
obtaining a symbol block containing a plurality of symbols on a plurality of tones, wherein the plurality of symbols include the at least one first symbol, wherein the first channel matrix is for a first tone of the plurality of tones, and wherein the at least one first symbol is on the first tone;
determining a precoding matrix for each tone of the plurality of tones other than the first tone;
applying the precoding matrix for each tone of the plurality of tones other than the first tone to one or more symbols of the plurality of symbols on the each respective tone to generate at least one precoded symbol on the each respective tone; and
transmitting the at least one precoded symbol on each respective tone of the plurality of tones other than the first tone.

13. The apparatus for wireless communication of claim 10, wherein a number of layers of the at least one first symbol is equal to a number of antennas of the first UE.

14. The apparatus for wireless communication of claim 10, wherein a number of layers of the at least one first symbol is less than a number of antennas of the first UE,
wherein the determination of the first precoding matrix includes selecting a subset of columns of a product of the right singular vector matrix and a conjugate transpose of the left singular vector matrix to form the first precoding matrix, wherein a number of columns in the subset is equal to the number of layers of the at least one first symbol.

15. The apparatus for wireless communication of claim 10, wherein a number of layers of the at least one first symbol is less than a number of antennas of the first UE, the method further comprising:
determining a subset of the antennas based on reception qualities of the antennas, wherein a number of antennas in the subset is equal to the number of layers of the at least one first symbol; and
removing rows not corresponding to the subset of antennas from the first channel matrix prior to the application of the SVD to the first channel matrix.

16. The apparatus for wireless communication of claim 15, wherein a reception quality of each of the antennas is determined based on an estimated total energy received at the each antenna.

17. The apparatus for wireless communication of claim 15, wherein the antennas in the subset each have a reception quality better than reception qualities of the antennas not included in the subset.

18. A computer-readable medium storing computer executable code for wireless communication at base station, comprising code to:
estimate a first channel matrix observed by a first user equipment (UE);
apply a singular value decomposition (SVD) to the first channel matrix to obtain a left singular vector matrix and a right singular vector matrix of the first channel matrix;
determine a first precoding matrix based on a product of the right singular vector matrix and a conjugate transpose of the left singular vector matrix;
apply the first precoding matrix to at least one first symbol to generate one or more precoded symbols; and
transmit the one or more precoded symbols.

19. A method of wireless communication of a base station, comprising:
estimating a respective first channel matrix observed by each of a plurality of user equipments (UEs);
selecting a subset of rows of the respective first channel matrix of each of the plurality of UEs based on a respective number of layers of symbols directed to the each UE;
determining an augmented channel matrix based on the subset of rows of the respective first channel matrix of each of the plurality of UEs;
determining a first precoding matrix based on the augmented channel matrix;
applying the first precoding matrix to at least one first symbol to generate one or more precoded symbols; and
transmitting the one or more precoded symbols.

20. The method of claim 19, wherein the respective first channel matrix observed by each of a plurality of UEs is estimated based on one or more sounding reference signals (SRSs) received from the each UE.

21. The method of claim 19, further comprising:
applying a singular value decomposition (SVD) to the augmented channel matrix to obtain a left singular vector matrix and a right singular vector matrix of the augmented channel matrix, wherein the first precoding matrix is determined based on the left singular vector matrix and the right singular vector matrix.

22. The method of claim 21, wherein the first precoding matrix is determined based on a product of the right singular vector matrix and a conjugate transpose of the left singular vector matrix.

23. The method of claim 19, wherein a number of rows in the subset of rows of the respective first channel matrix of each of the plurality of UEs is equal to the respective number of layers directed to the each UE.

24. The method of claim 19, further comprising:
determining a subset of antennas from antennas of each of the plurality of UEs based on reception qualities of the antennas, the subset of rows of the respective first channel matrix of the each UE being determined based on the subset of the antennas.

25. The method of claim 24, wherein a reception quality of each of the antennas of each of the plurality of UEs is determined based on an estimated total energy received at the each antenna.

26. The method of claim 19, further comprising:
obtaining a symbol block containing a plurality of symbols on a plurality of tones, wherein the plurality of symbols include the at least one first symbol, wherein the first channel matrix is for a first tone of the plurality of tones, and wherein the at least one first symbol is on the first tone;
determining a precoding matrix for each tone of the plurality of tones other than the first tone;
applying the precoding matrix for each tone of the plurality of tones other than the first tone to one or more symbols of the plurality of symbols on the each respective tone to generate at least one precoded symbol on the each respective tone; and
transmitting the at least one precoded symbol on each respective tone of the plurality of tones other than the first tone.

27. An apparatus for wireless communication, the apparatus being a base station, comprising:
means for estimating a respective first channel matrix observed by each of a plurality of user equipments (UEs);
means for selecting a subset of rows of the respective first channel matrix of each of the plurality of UEs based on a respective number of layers of symbols directed to the each UE;
means for determining an augmented channel matrix based on the subset of rows of the respective first channel matrix of each of the plurality of UEs;
means for determining a first precoding matrix based on the augmented channel matrix;
means for applying the first precoding matrix to at least one first symbol to generate one or more precoded symbols; and
means for transmitting the one or more precoded symbols.

28. An apparatus for wireless communication, the apparatus being a base station, comprising:
a memory; and
at least one processor coupled to the memory and configured to:
estimate a respective first channel matrix observed by each of a plurality of user equipments (UEs);
select a subset of rows of the respective first channel matrix of each of the plurality of UEs based on a respective number of layers of symbols directed to the each UE;
determine an augmented channel matrix based on the subset of rows of the respective first channel matrix of each of the plurality of UEs;
determine a first precoding matrix based on the augmented channel matrix;
apply the first precoding matrix to at least one first symbol to generate one or more precoded symbols; and
transmit the one or more precoded symbols.

29. The apparatus for wireless communication of claim 28, wherein the respective first channel matrix observed by each of a plurality of UEs is estimated based on one or more sounding reference signals (SRSs) received from the each UE.

30. The apparatus for wireless communication of claim 28, further comprising:
applying a singular value decomposition (SVD) to the augmented channel matrix to obtain a left singular vector matrix and a right singular vector matrix of the augmented channel matrix, wherein the first precoding matrix is determined based on the left singular vector matrix and the right singular vector matrix.

31. The apparatus for wireless communication of claim 30, wherein the first precoding matrix is determined based on a product of the right singular vector matrix and a conjugate transpose of the left singular vector matrix.

32. The apparatus for wireless communication of claim 28, wherein a number of rows in the subset of rows of the respective first channel matrix of each of the plurality of UEs is equal to the respective number of layers directed to the each UE.

33. The apparatus for wireless communication of claim 28, further comprising:
determining a subset of antennas from antennas of each of the plurality of UEs based on reception qualities of the antennas, the subset of rows of the respective first channel matrix of the each UE being determined based on the subset of the antennas.

34. The apparatus for wireless communication of claim 33, wherein a reception quality of each of the antennas of each of the plurality of UEs is determined based on an estimated total energy received at the each antenna.

35. The apparatus for wireless communication of claim 28, further comprising:
obtaining a symbol block containing a plurality of symbols on a plurality of tones, wherein the plurality of symbols include the at least one first symbol, wherein the first channel matrix is for a first tone of the plurality of tones, and wherein the at least one first symbol is on the first tone;
determining a precoding matrix for each tone of the plurality of tones other than the first tone;
applying the precoding matrix for each tone of the plurality of tones other than the first tone to one or more symbols of the plurality of symbols on the each respective tone to generate at least one precoded symbol on the each respective tone; and
transmitting the at least one precoded symbol on each respective tone of the plurality of tones other than the first tone.

36. A computer-readable medium storing computer executable code for wireless communication at base station, comprising code to:
estimate a respective first channel matrix observed by each of a plurality of user equipments (UEs);
select a subset of rows of the respective first channel matrix of each of the plurality of UEs based on a respective number of layers of symbols directed to the each UE;
determine an augmented channel matrix based on the subset of rows of the respective first channel matrix of each of the plurality of UEs;
determine a first precoding matrix based on the augmented channel matrix;
apply the first precoding matrix to at least one first symbol to generate one or more precoded symbols; and
transmit the one or more precoded symbols.
